(19) United States
(12) Patent Application Publication
(10) Pub. No.: US 2011/0158282 A1
(43) Pub. Date: Jun. 30, 2011

(54) METHOD FOR DETECTING CHANGES IN A VACUUM STATE IN A DETECTOR OF A THERMAL CAMERA

(75) Inventor: Rammy Hartman, MaAlot (IL)

(73) Assignee: Opgal Optronic Industries Ltd.

(21) Appl. No.: 13/060,281

(22) PCT Filed: Aug. 6, 2009
(86) PCT No.: PCT/IL09/00768

§ 371 Date: Feb. 23, 2011

Related U.S. Application Data
(60) Provisional application No. 61/092,440, filed on Aug. 28, 2008.

(51) Int. Cl. G01K 13/00; G01N 25/00

(52) U.S. Cl. 374/45; 374/E13.001

(57) ABSTRACT

A method for detecting a change in a vacuum state within a sealed thermal detector package which is a part of a thermal camera, the package housing a thermal detector array and at least one temperature sensor. The method comprises measuring an initial signal from said thermal detector array; concurrently measuring an initial signal from said at least one temperature sensor; measuring a later signal from said thermal detector array; concurrently measuring a later signal from said at least one temperature sensor; performing a first calculation of a ratio of the difference between the later and initial signals from said thermal detector array to the difference between the later and initial signals from said at least one temperature sensor; and periodically measuring the initial and later signals from said thermal detector array and from said at least one temperature sensor and calculating the ratio to determine changes in the ratio indicative of changes in the vacuum state within the package.

### FIELD OF THE INVENTION

The present invention relates to detecting changes in a vacuum state. More specifically, the present invention relates to detecting a change in a vacuum state within a sealed thermal detector package which is a part of a thermal camera.

### BACKGROUND OF THE INVENTION

An uncooled infrared thermal camera creates an image that represents the distribution of radiation that originates from a scene. The detector of an uncooled infrared thermal camera is enclosed in a vacuum package that is evacuated and sealed during manufacture of an uncooled detector.

Sometimes, after the manufacture process, the gas pressure inside the vacuum package increases and the vacuum degrades, Degradation of the vacuum in the vacuum package could lead to degradation of the accuracy of the image created by the camera. If the vacuum loss is detected when the loss of vacuum is still small, the loss of vacuum may be correctable by a simple corrective action, possibly on site. Such corrective maintenance could include relatively simple actions such as flashing a getter. However, a small loss of vacuum that is correctable by simple means would likely not have a sufficiently noticeable effect on image quality to be detected.

A more serious loss of vacuum inside the vacuum package may require repairs involving more complex, time-consuming, and expensive procedures.

On the other hand, flashing a getter as a preventative measure, without any indication of loss of vacuum, is also not desirable. Flashing a getter more often than required could lead to deterioration of the detector.

Therefore, there is a need for timely detection of loss of vacuum in the vacuum package surrounding the detector of an uncooled infrared camera.

It is an object of the present invention to provide for timely detection of loss of vacuum in the vacuum package surrounding the detector of an uncooled infrared camera during the course of routine use of the camera, and to inform the camera operator of such loss.

### SUMMARY OF THE INVENTION

There is thus provided, according to embodiments of the present invention, a method for detecting a change in a vacuum state within a sealed thermal detector package which is a part of a thermal camera, the package housing a thermal detector array and at least one temperature sensor, the method comprising:

measuring an initial signal from said thermal detector array;

concurrently measuring an initial signal from said at least one temperature sensor;

measuring a later signal from said thermal detector array;

concurrently measuring a later signal from said at least one temperature sensor;

performing a first calculation of a ratio of the difference between the later and initial signals from said thermal detector array to the difference between the later and initial signals from said at least one temperature sensor; and

periodically measuring the initial and later signals from said thermal detector array and from said at least one temperature sensor and calculating the ratio to determine changes in the ratio indicative of changes in the vacuum state within the package.

Furthermore, according to embodiments of the present invention, the first calculation is performed during a manufacturing process of the thermal camera.

Furthermore, according to embodiments of the present invention, the thermal camera is provided with a shutter the method further comprising using the shutter to block thermal radiation from entering into the thermal detector package during the periodical measurements.

Furthermore, according to embodiments of the present invention, the thermal camera is directed at a scene characterized by homogeneous thermal radiation.

Furthermore, according to embodiments of the present invention, the signals from said thermal detector array are converted to grey-scale values.

Furthermore, according to embodiments of the present invention, the sealed thermal detector package comprises at least one temperature stabilizer in thermal contact with the thermal detector array, and the method further comprises operating the temperature-stabilizing element so as to produce the difference between the later and initial signals from said thermal detector array.

Furthermore, according to embodiments of the present invention, the thermal stabilizer comprises a thermo-electric element.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a block diagram of an uncooled infrared camera in accordance with embodiments of the present invention.

FIG. 2 is a block diagram of control of an uncooled infrared camera in accordance with embodiments of the present invention.

FIG. 3A is a flow chart of acquisition of a reference value in accordance with embodiments of the present invention.

FIG. 3B is a variation of the flow chart of FIG. 3A.

FIG. 4A is a flow chart of checking for possible loss of vacuum in accordance with embodiments of the present invention.

FIG. 4B is a variation of the flow chart of FIG. 4A.

### DETAILED DESCRIPTION OF EMBODIMENTS

Embodiments of the present invention provide for checking for changes in the level of vacuum in a vacuum package that surrounds the detector of an uncooled thermal infrared camera.

The principles and operation of checking for changes in the vacuum level in a vacuum package surrounding the detector array of an uncooled infrared camera, according to embodiments of the present invention, may be better understood with reference to the drawings and the accompanying description.

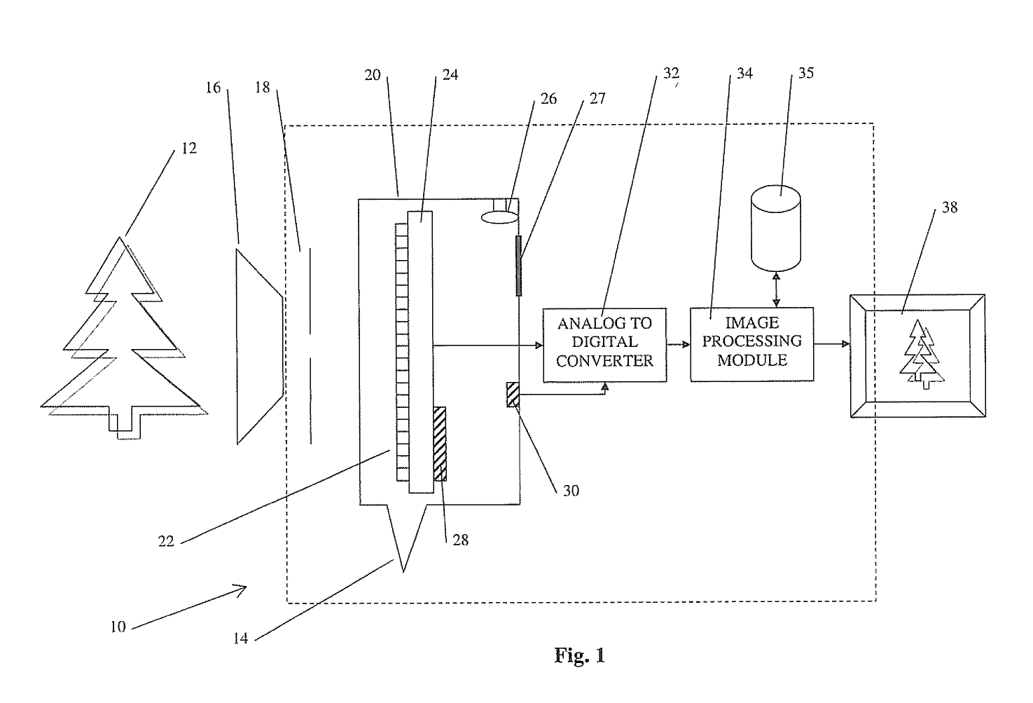

FIG. 1 is a block diagram of an uncooled thermal infrared camera in accordance with embodiments of the present invention. The main function of camera 10 is to create an image on display device 38 that represents radiation that originates from scene 12. Shutter 18 may be opened or closed by a suitable mechanism (not shown). When shutter 18 is open, scene 12 may irradiate upon the surface of detector array 22 through optics 16. Detector array 22 comprises an array of individual detector elements. When shutter 18 is closed, direct irradiation from scene 12 upon detector array 22 is blocked.

Detector array 22 is located within vacuum package 20. A temperature stabilizing element, for example thermoelectric element 28, is in thermal contact with detector array 22. Thermoelectric element 28 generates or absorbs heat in accordance with a voltage that is applied to it. Temperature sensor 30 is affixed to vacuum package 20.

Readout circuits 24 are associated with detector array 22. Each detector element of detector array 22 is associated with one of readout circuits 24. Each readout circuit 24 creates an analog electrical signal.

Detector array 22 is encapsulated in a vacuum package 20. During manufacture of uncooled detector 20, a vacuum pump pumps gas out of vacuum package 20 via nozzle 14. Once a vacuum is formed inside vacuum package 20, nozzle 14 is sealed.

In order to assist in maintaining a vacuum inside vacuum package 20, a getter 26 is provided inside vacuum package 20. When getter 26 is heated or flashed, material from getter 26 is deposited in a layer 27 on an inner wall of vacuum package 20. The material in layer 27 traps gas that is present in vacuum package 20, thus maintaining the level of the vacuum inside vacuum package 20.

Analog-to-digital converter 28 converts analog electrical signals to digital signals. Analog signals include the signals that are created by readout circuits 24, and the output of temperature sensor 30.

Image processing module 34 processes the digital output of analog-to-digital converter 32. Image processing module 34 includes processing circuitry and programmed instructions. Image processing module 34 communicates with data-storage device 35. During image creation, image processing module 34 calculates pixel gray-level values based on the digital output of analog-to-digital converter 32. Pixel gray-level values may be displayed graphically on display device 32. Pixel gray-level values may also be stored on data-storage device 35.

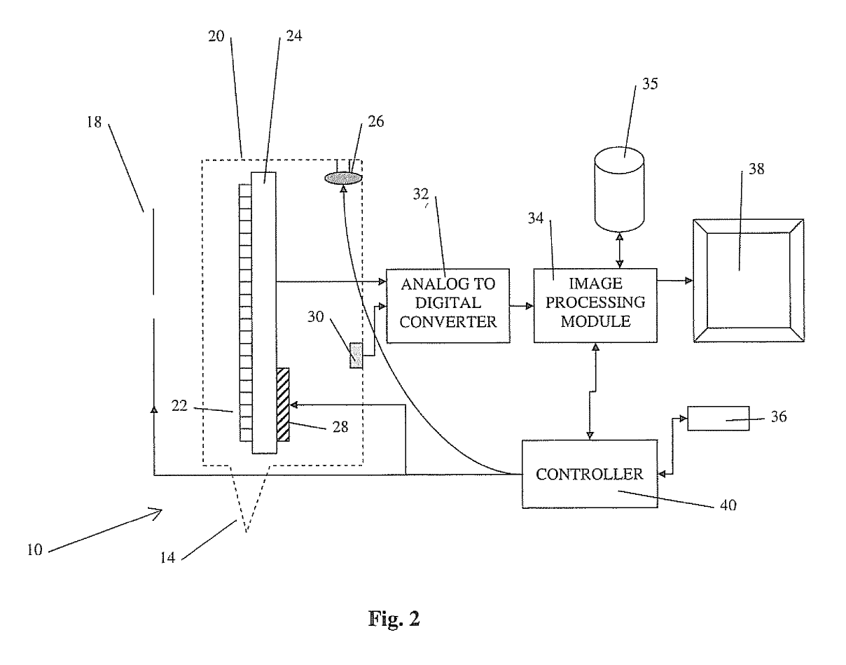

FIG. 2 is a block diagram of control of an uncooled infrared camera in accordance with embodiments of the present invention. Serial port 36 communicates with external devices. External devices may include operator controls, or external displays, data storage devices, or processors. Instructions may be entered via serial port 36. Serial port 36 communicates with controller 40. Controller 40 may control components of camera 10. For example, controller 40 may cause shutter 18 to open or close, may apply a voltage to thermoelectric element 28 causing it to generate or absorb heat, and may cause the flashing of getter 26. Controller 40 communicates with image processing module 34.

Image processing module 34 may receive digital input from detector array 22 via the readout circuits 24 and analog-to-digital converter 32. Image processing module 34 may convert digital input from detector array 22 to gray level values. Image processing module 34 may also receive digital input from temperature sensor 30 via analog-to-digital converter 32. Image processing module 34 may convert digital input from temperature sensor 30 to temperature data. Image processing module 34 may display image and text data on display device 38. Image processing module 34 may save data on data-storage device 35, or retrieve data from data-storage device 35. Image processing module 34 may communicate with controller 40 to send and receive data via serial port 36.

Referring to FIG. 1, and in accordance with the method of embodiments of the present invention, changes in the outputs of both detector array 22 and temperature sensor 30 under the influence of thermoelectric element 28 are measured when the vacuum level in vacuum package 20 is assumed to be at the desired level. Should a similar measurement made at a later date indicate different changes in output, this would imply a change in the vacuum level.

In embodiments of the present invention, the average output of detector elements of detector array 22 is expressed by the average of the gray-level values that correspond to those detector elements. Average gray-level values are calculated by image-processing module 34 on the basis of digitized data from readout circuits 24.

When shutter 18 is open, exchange of radiation between scene 12 and detector array 22 may affect the output of detector array 22. The content of scene 12 would be likely to vary from output measurement to output measurement. The measured change in output of detector array 22 could then be influenced by the changes in the content of scene 12. Measured changes in output of detector array 22 then would not reliably correlate with the level of vacuum. Therefore, when measuring the output of detector array 22, shutter 18 is closed to prevent the direct exchange of radiation between scene 12 and detector array 22. When shutter 18 is closed, shutter 18 presents detector array 22 with a source of radiation that, in general, is more uniform and reproducible than scene 12. Alternatively, camera optics 16 could be aimed at a non-reflecting surface that emits radiation uniformly and homogenously. For example, camera optics 16 could be aimed at a black body surface or cavity, where the black body is kept at a uniform temperature and fills the field of view of camera 10.

In addition, in accordance with embodiments of the present invention, changes in the digitized output signal of temperature sensor 30 are measured.

The outputs of detector array 22 and temperature sensor 30 are measured concurrently, and at least twice during determination of the output changes. In between measurements, thermoelectric element 28 is operated. Operation of thermoelectric element 28 may cause the temperatures of detector array 22 and temperature sensor 30 to change, each at its own rate. The ratio of the change in the output of detector array 22 to the change in the output of sensor 30 may be calculated. This output-change ratio, in essence, expresses the rate of the change in the output of detector array 22 as a multiple or fraction of the rate of the change in the output of temperature sensor 30. The value of the output-change ratio correlates the state of the vacuum inside vacuum package 20.

In accordance with embodiments of the present invention, the output-change ratio is first measured during the process of manufacturing an uncooled infrared camera. Gas is evacuated from vacuum package 20 to a desired level during the manufacturing process of the detector. It may be assumed that the gas pressure in vacuum package 20 shortly after evacuation is at a desired level. The value of the output-change ratio that is measured during the manufacturing process of the infrared camera can be recorded as a reference value. Measurement of the output-change ratio at a later date may be expected to correlate with the state of the vacuum inside vacuum package 20. A significant difference between the output-change ratio measured at a later date and the recorded reference value would imply a change in gas pressure, i.e. a change in the level of vacuum, inside vacuum package 20.

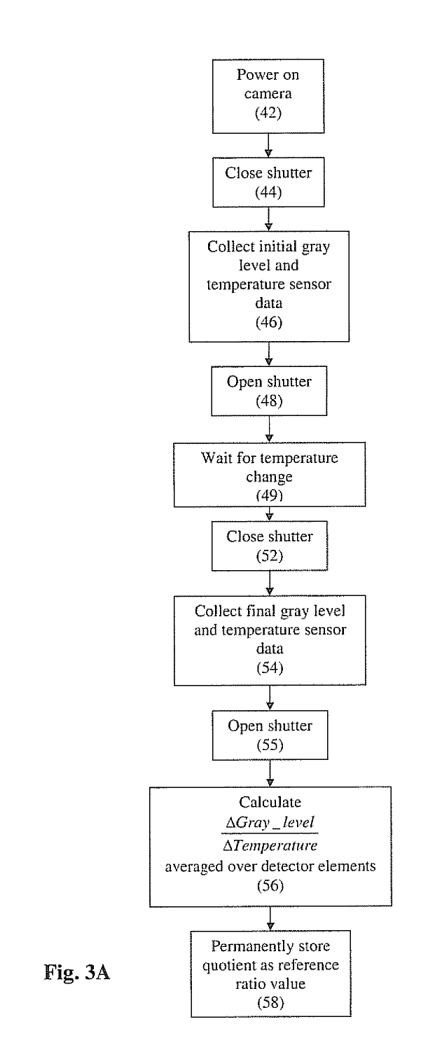

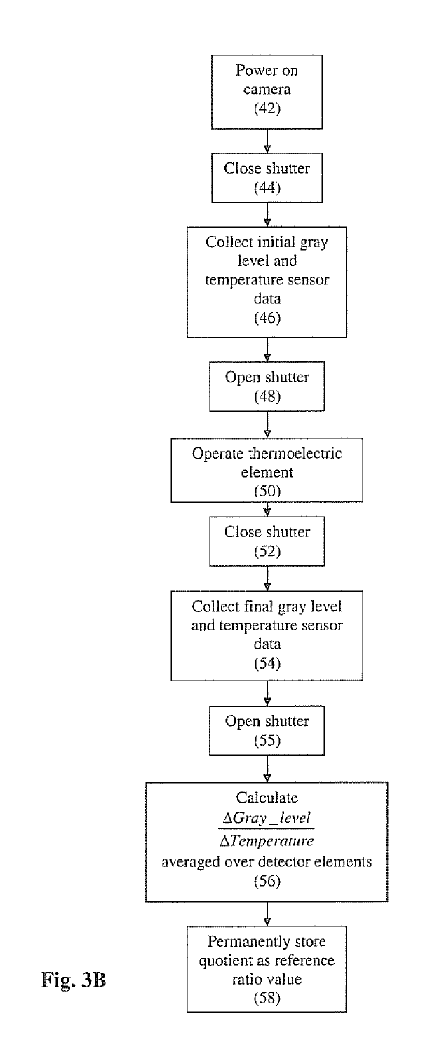

FIG. 3A is a flow chart of acquisition of a reference value in accordance with embodiments of the present invention. FIG. 3B is a variation of the flow chart of FIG. 3A. In the description of the acquisition of a reference value, reference is made to steps of the flow charts in FIG. 3A and FIG. 3B, and to control components in FIG. 2.

During the manufacture process of an uncooled infrared camera 10, the vacuum inside vacuum package 20 may be assumed to be at an acceptable level. Power to the camera is turned on (step 42). Controller 40 causes shutter 18 to close (step 44). Image processing module 34 acquires output data from detector array 22 and readout circuits 24 via analog-to-digital converter 32, and processes the data to yield initial gray-level values for detector elements of detector array 22 (step 46). Concurrently, image processing module 34 acquires an initial output value from temperature sensor 30 via analog-to-digital converter 32. Controller 40 causes shutter 18 to open (step 48). At this point, the camera is allowed to operate for an interval of time, during which the temperature of components in vacuum package 20 may change (step 49 of FIG. 3A). Alternatively, controller 40 operates thermoelectric element 28 to generate or absorb heat (step 50 of FIG. 3B) for an interval of time. The length of the interval of step 49 or step 50 may be determined by a timer circuit incorporated into, or associated with, image processing module 34, or may be determined by sampling output of temperature sensor 30 until a predetermined output value, or change in output value, is attained. At the end of the interval, controller 40 causes shutter 18 to close (step 52). Image processing module 34 collects output data from detector array 22 and processes the data to yield final gray-level values for detector elements. Concurrently, image processing module 34 acquires a final value from temperature sensor 30 (step 54). Controller 40 causes shutter 18 to open to enable normal camera operation (step 55). For each detector element, the initial gray-level value is subtracted from the corresponding final gray-level value. This difference result is referred to in step 56 as ΔGray_level. Also, the initial temperature sensor output value is subtracted from the final temperature sensor output value to yield ΔTemperature. The average value of ΔGray_level is calculated. The values of ΔGray_level may be averaged for all detector elements, or for a subset of the detector elements. The average value of ΔGray_level is divided by ΔTemperature (step 56). Image processing module 34 permanently stores this quotient, the initial output-change ratio, as a reference value in data storage device 35 (step 58). The stored reference value may be compared at a later date with a value of the output-change ratio calculated on that later date.

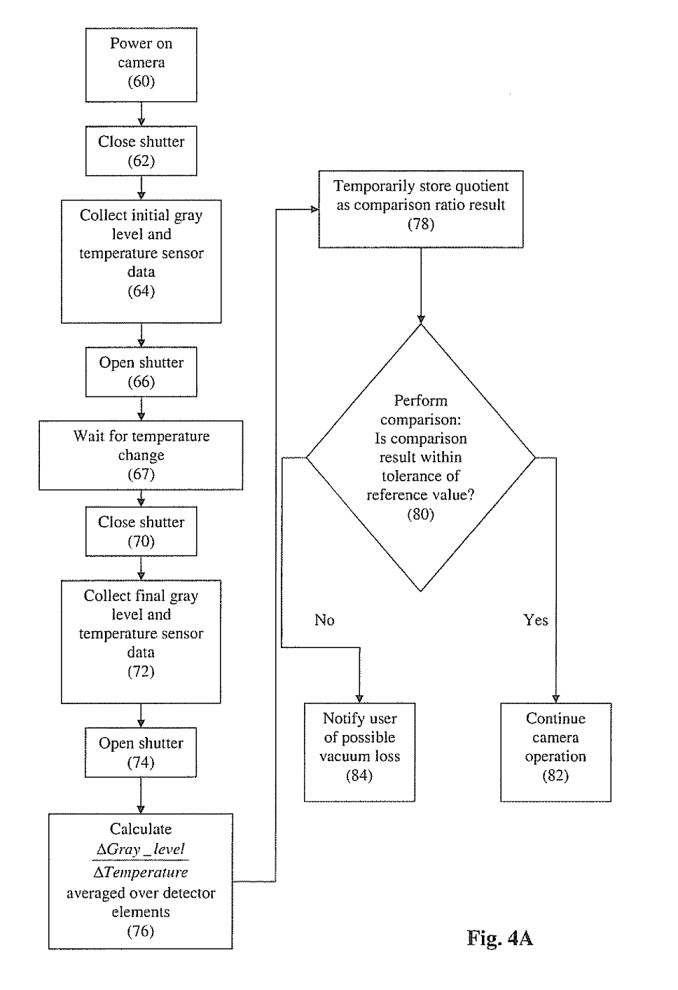

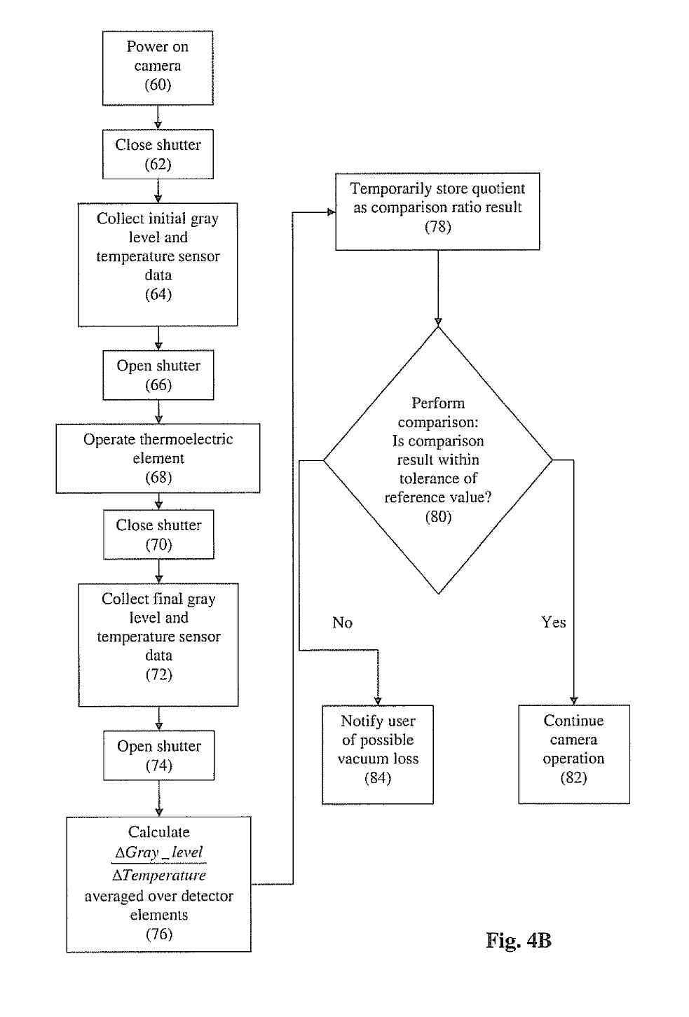

FIG. 4A is a flow chart of checking for possible loss of vacuum in accordance with embodiments of the present invention. FIG. 4B is a variation of the flow chart of FIG. 4A. In the description of checking for possible loss of vacuum, reference is made to steps of the flow charts in FIG. 4A and FIG. 4B, and to control components in FIG. 2.

In embodiments of the present invention, acquisition and calculation of a value for comparison with a stored reference value occurs whenever electric power supply 39 is connected to controller 40 of uncooled infrared camera 10 is turned on (step 60). Controller 40 causes shutter 18 to close (step 62). Image processing module 34 acquires output data from detector array 22 and readout circuits 24 via analog-to-digital converter 32, and processes the data to yield initial gray-level values for detector elements of detector array 22. Concurrently, image processing module 34 acquires an initial output value from temperature sensor 30 via analog-to-digital converter 32 (step 64). Controller 40 causes shutter 18 to open (step 66). At this point, the camera is allowed to operate for an interval of time, during which the temperature of components in vacuum package 20 may change (step 67 of FIG. 4A). Alternatively, controller 40 causes thermoelectric element 28 to generate or absorb heat (step 68 of FIG. 4B) for an interval of time. At the end of the interval, controller 40 causes shutter 18 to close (step 70). Image processing module 34 collects output data from detector array 22 and processes the data to yield final gray-level values for each detector element. Concurrently, image processing module 34 acquires a final output value from temperature sensor 30 (step 72). Controller 40 causes shutter 18 to open (step 74). For each detector element, the initial gray-level value is subtracted from the corresponding final gray-level value. This difference result is referred to in step 76 as ΔGray_level. Also, the initial temperature sensor output value is subtracted from the final temperature sensor output value to yield ΔTemperature. The average value of ΔGray_level is calculated and divided by ΔTemperature (step 76). Image processing module 34 temporarily stores this quotient, the output-change ratio, as a comparison result (step 58). The comparison result is stored until power to camera 10 is shut off.

Once the comparison result is calculated and temporarily stored, the comparison result is compared with the permanently stored reference value (step 82). This comparison may be made immediately after storing the comparison result, as part of a built-in test procedure that is performed upon camera startup. Alternatively, the comparison may be initiated by a command received via serial port 36. Alternatively, the comparison may be initiated by a component of the camera, for example image processing module 34, when predetermined conditions are met. Comparison of the comparison result with the reference value entails checking whether the value of the current comparison result is within a predefined tolerance range of the reference value. Such a tolerance range may be defined, for example, in terms of a fraction or percentage of the reference value. In this case, the comparison result would first be subtracted from the reference value. The absolute value of the difference would then be divided by the reference value. If the value of the resulting quotient is found to be below a defined tolerance value, the comparison result is considered to fall within the tolerance range of the reference value.

If the comparison result falls within a predefined tolerance range of the permanently stored reference value, the comparison is taken to indicate that the vacuum in vacuum package 20 is intact. Operation of the camera then continues. Image processing module 34 may then display text or symbols on display device 38 indicating that the vacuum is intact, or may send such an indication to an external device via serial port 36.

If the comparison result does not fall within the predefined tolerance range of the permanently stored reference value, the comparison is taken to indicate that gas is present within vacuum package 20. Image processing module 34 may then display text or symbols on display device 38 indicating the loss of vacuum, or may send such an indication to an external device via serial port 36.

When loss of vacuum is indicated, one or more courses of action may be taken. Getter 26 may be flashed to remove trace gasses from vacuum package 20. Flashing of getter 26 may be caused by controller 40 in response to instructions received via serial port 36 from an external device. Alternatively, getter 26 may be flashed by means of a device that is connected directly to leads that are connected to getter 26. If a vacuum check performed after flashing getter 26 continues to indicate loss of vacuum, other courses of action may be taken. Vacuum may be reestablished in vacuum package 20, for example, by opening nozzle 14 of vacuum package 20, using a vacuum pump to remove gas from inside vacuum package 20, and resealing nozzle 14. If vacuum cannot be reestablished in vacuum package 20, the detector can be declared as a damaged.

Alternatively, the comparison of the comparison result for the output-change ratio with the reference result may be calibrated to yield an indication of the extent of vacuum loss. An indication of the extent of vacuum loss may then immediately indicate a recommended course of remedial action.

As described above, embodiments of the present invention provide for checking the status of the vacuum in a package surrounding the detector array of an uncooled infrared camera. Checking the vacuum may be performed routinely within the camera during camera startup, without the need for external equipment.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for detecting a change in a vacuum state within a sealed thermal detector package which is a part of a thermal camera, the package housing a thermal detector array and at least one temperature sensor, the method comprising:
measuring from said thermal detector array an initial signal indicative of thermal radiation incident thereon;
concurrently measuring from said at least one temperature sensor an initial signal indicative of an initial temperature in the package;
measuring from said thermal detector array a later signal indicative of thermal radiation incident thereon;
concurrently measuring from said at least one temperature sensor a later signal indicative of a later temperature in the package, said later temperature being different from said initial temperature;
calculating a ratio of the difference between the later and initial signals from said thermal detector array to the difference between the later and initial signals from said at least one temperature sensor;
comparing said ratio to a reference ratio; and
determining a change in the vacuum state within the package based on said ratio.

2. The method as claimed in claim 1, wherein said reference ratio corresponds to a vacuum state of the package during a manufacturing process of the thermal detector package.

3. The method as claimed in claim 1, wherein the thermal camera is provided with a shutter the method further comprising using the shutter to block thermal radiation from entering into the thermal detector package during the periodical measurements.

4. The method as claimed in claim 1, wherein the thermal camera is directed at a scene characterized by homogeneous thermal radiation.

5. The method as claimed in claim 1, wherein the signals from said thermal detector array are converted to grey-scale values.

6. The method as claimed in claim 1, wherein the sealed thermal detector package comprises at least one temperature stabilizer in thermal contact with the thermal detector array, the method further comprising operating the temperature-stabilizing element so as to produce the difference between the later and initial signals from said thermal detector array

7. The method as claimed in claim 6, wherein the thermal stabilizer comprises a thermo-electric element.

8. The method as claimed in claim 1, further comprising calculating said reference ratio.

9. The method as claimed in claim 1, further comprising repeating said measurements, said calculation, said comparison and said determination of vacuum state at least once.

10. The method as claimed in claim 1, further comprising alerting when said comparison exceeds a predefined tolerance range.

11. The method as claimed in claim 1, wherein the sealed thermal detector package comprises a getter, and the method further comprises activating said getter when said comparison exceeds a predefined tolerance range.
